(19) United States
(12) Patent Application Publication
(10) Pub. No.: US 2012/0163976 A1
(43) Pub. Date: Jun. 28, 2012

(54) VERTICAL AXIS TURBINE BLADE WITH ADJUSTABLE FORM

(76) Inventors: Nelson C. BATISTA, Covilha (PT); Rui MELÍCIO, Covilha (PT); João P.S. CATALÃO, Covilha (PT)

(21) Appl. No.: 13/331,561

(22) Filed: Dec. 20, 2011

(30) Foreign Application Priority Data
Dec. 22, 2010 (PT) 105445

(51) Int. Cl. F03D 7/06

(52) U.S. Cl. 416/120

(57) ABSTRACT

The disclosed subject matter provides blades for vertical axis turbines capable of being operated by airflow and/or fluid. The turbine performance is optimized and adjusted with respect to an installation site adapting the turbine to the site and flow needs by modifying the blade's form. The blades can be configured so as to be capable of adjusting the position angle of its ends, leading to an increase in stability, particularly when the turbine reaches high rotational speeds. This configuration also provides the turbine with the ability to self-start more efficiently. The changeable blade ends can give the turbine the ability to absorb the energy of the fluid flow when it reaches the turbine at almost any angle in a vertical or horizontal plane and therebetween.

### RELATED CASE INFORMATION

This application claims the priority benefit under 35 U.S.C. §119 of Portugal Patent Application No. 105445 filed on Dec. 22, 2010, which is hereby incorporated in its entirety by reference.

### BACKGROUND

(1) Field of the Disclosed Subject Matter

The presently disclosed subject matter relates to a vertical axis turbine blade operated by fluid such as airflow, hydraulic flow, etc., and particularly, to a vertical axis turbine with blades that change their form to optimize the turbine performance.

(2) Background Art

An increased acceptance of energy production from renewable sources has been driven by the increasing cost of fossil fuels and the aim of reducing CO₂ emissions.

Wind energy systems have been considered as one of the most cost effective of all the currently exploited renewable sources, so the demand and investment in wind energy systems has increased in the last decade.

Decentralized energy generation is an important solution in a smarter electrical grid with a growing acceptance for the urban areas. Also, the increasing need for more environmentally sustainable housing and the new norms regulating this issue, have contributed for the promotion of wind energy systems in buildings.

In urban areas, the wind is often very turbulent and unstable with fast changes in direction and velocity. In these environments, vertical axis wind turbines (VAWT) have several advantages over horizontal axis wind turbines (HAWT). Examples of these advantages are: their insensitivity to yaw wind direction; smaller number of components; very low sound emissions; the ability to generate energy from wind in skewed flow; and the ability to operate closer to the ground level.

The Darrieus type vertical axis turbines were described in U.S. Pat. No. 1,835,018.

One problem with the Darrieus type vertical axis turbines is their inability to self-start. Several solutions have been presented to overcome this problem: use of a guide-vane as in U.S. Pat. No. 4,156,580 (“Wind-turbine”) or as in U.S. Pat. No. 7,315,093 (“Wind Turbine System for Buildings”); using a hybrid configuration of a Savonius VAWT (drag type wind turbine) and a Darrieus VAWT (lift type wind turbine); use of mechanical system to optimize the blade pitch as in U.S. Pat. No. 6,320,273 (“Large Vertical-axis Variable-pitch Wind Turbine”); use of blades that change their form during operation as in U.S. Pat. Application No. 2010/0054936 (“Vertical Axis Wind Turbine”); use of a wind turbine concentrator to optimize the wind flow.

### SUMMARY OF THE DISCLOSED SUBJECT MATTER

This present disclosure presents a specific blade capable of changing its form in order to offer self-start capabilities to a VAWT without extra components while providing high performance when the turbine reaches high rotation speed.

In accordance with the disclosed embodiment, blades can be provided which change their end form in order to optimize the turbine performance. The ends of the blades can change their position angle towards the inside or towards the outside of the rotor.

With this blade configuration, the wind turbine can take full advantage of the flow energy wherever it reaches the turbine in almost any horizontal angle (5) or vertical angle (4) in relation to the rotor position. When the blade ends are positioned to the inside or outside of the rotor, an increase in drag is generated by an increase of the blade profile height, leading to an increased ability of the turbine to self-start and leading to an increase in the turbine stability when it reaches high rotation speeds, while maintaining other desirable properties, including, the ability to operate in very turbulent and unstable winds with fast changes in direction and velocity, insensitivity to yaw wind direction, low number of components, very low sound emissions, able to generate energy from wind in skewed flow, able to operate close to the ground level, etc.

It should be understood that vertical in the sense of the presently disclosed subject matter means the operation of the turbine axis substantially perpendicular to the airflow; and horizontal means the operation substantially parallel to the airflow; it does not necessarily imply perpendicular operation relative to the horizontal level, in particular a ground plane.

It should be understood that airflow substantially perpendicular to the turbine axis should also be interpreted very broadly, as it is one of the advantageous features of the presently disclosed subject matter to operate at almost any airflow angle relative to the turbine axis.

It should be understood that airflow also means any appropriate fluid able to operate the turbine of the presently disclosed subject matter; it does not imply the exclusive use in air or in natural airflow conditions, in particular wind.

The presently disclosed subject matter describes a vertical axis turbine blade, having one or two ends, wherein one or two of said blade ends are arranged to have a variable position angle relative to the main blade body, either towards the inside or outside of the rotor of said turbine.

In an embodiment, the disclosed subject matter includes two blade ends, wherein both of said blade ends are arranged to have a variable position angle towards the inside of the rotor of said turbine.

In an embodiment, the blade is elliptical and the ellipse small axis has a transverse position in relation to the rotor of said turbine.

An embodiment also includes one or more arms connected to the blade and to the rotor of said turbine.

In an embodiment the variable position angle of said blade ends is fixed at its fabrication.

In an embodiment the variable position angle of said blade ends is variable in operation.

In an embodiment the blade further comprises a mechanism inside the blade, arranged such that said blade ends have a variable position angle, either towards the inside or outside of the rotor of said turbine.

In an embodiment the blade ends are substantially placed in the same angular position towards the rotor axis of the turbine, thus the blade is substantially vertical.

In an embodiment the blade ends are not substantially placed in the same angular position towards the rotor axis of the turbine, thus the blade can be helical.

In an embodiment, the blade end profile height, when the variable position angle is not null, from the airflow perspective, is substantially higher than the normal blade main body profile height and the blade ends profile when the variable position angle is null.

The presently disclosed subject matter also describes a vertical axis turbine comprising one or more blades according to the above description.

### BRIEF DESCRIPTION OF THE DRAWINGS

The figures are provided as illustrations which facilitate an understanding of the disclosed subject matter and are not to be seen as limiting the scope of the disclosed subject matter, but merely illustrating some of the embodiments of the disclosed subject matter.

FIGS. 1 A and B are perspective views of two vertical axis turbines, according to an embodiment of the presently disclosed subject matter, the first with the ends of the blades with no modification (A); and the second having ends of the blades with a modification angle towards the inside of the wind turbine (B).

FIG. 2 shows the horizontal plane (5) angles and vertical plane (4) angles of the flow when it reaches the exemplary turbine of FIGS. 1A and B.

FIGS. 3 A and B are side views showing the main turbine blade components of the exemplary turbine of FIGS. 1 A and B.

FIGS. 4 A and B show the blade ends components of the exemplary turbine of FIGS. 1 A and B.

FIGS. 5 A-D′ present some examples of the blade with the blade ends in different positions, with FIGS. 5A,A′ depicting a side and top view, respectively, of a blade in an extended configuration; FIGS. 5B,B′ depicting a side and top view of the blade of FIGS. 5A, A′, respectively, in an articulated configuration; FIGS. 5C,C′ depicting a side and top view, respectively, of a helical blade in extended configuration; and FIGS. 5D,D′ depicting a side and top view of the blade of FIGS. 5C, C′, respectively, in an articulated configuration.

FIGS. 6 A-C are cross-sectional profiles of different blade profiles of the airfoils as shown in FIG. 3.

### DETAILED DESCRIPTION OF EXEMPLARY EMBODIMENTS

This disclosed subject matter presents technical innovations in blades for vertical axis turbines operated by fluid, such as airflow/wind, hydraulic or other fluids. The turbines that have these blades installed present an enhanced performance in the operation, in particular when operated in fluids (such as wind) with high turbulence.

A growing acceptance of the energy production from renewable sources has been stimulated by the increase in the price of fossil fuels and by the aims of reducing carbon dioxide emissions. The wind has been considered one of the best energy sources with the best balance between costs and benefits, leading to increased investment recently.

The need to assure the diversity, security and quality in the delivery of electrical energy in urban areas has been increasing with increasing energy needs. The growing acceptance of electrical vehicles as a means of transport will lead to an exponential growth of electrical energy needs. More than ever, there is the need for decentralized electrical energy production, as a means of increasing the sustainability of urban areas, to culminate energy needs and to reduce electrical grid upgrade and maintenance costs.

In urban areas, the wind is very turbulent and unstable with fast changes in direction and velocity. In these urban areas, vertical axis wind turbines (VAWT) have several advantages over horizontal axis wind turbines (HAWT). These advantages include: insensitivity to yaw wind direction; smaller number of components; very low sound emissions; the ability to generate energy from wind in skewed flow; the ability to operate closer to the ground level.

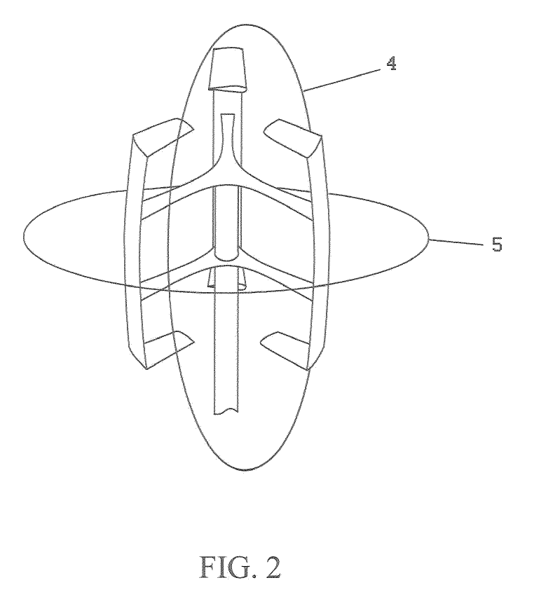

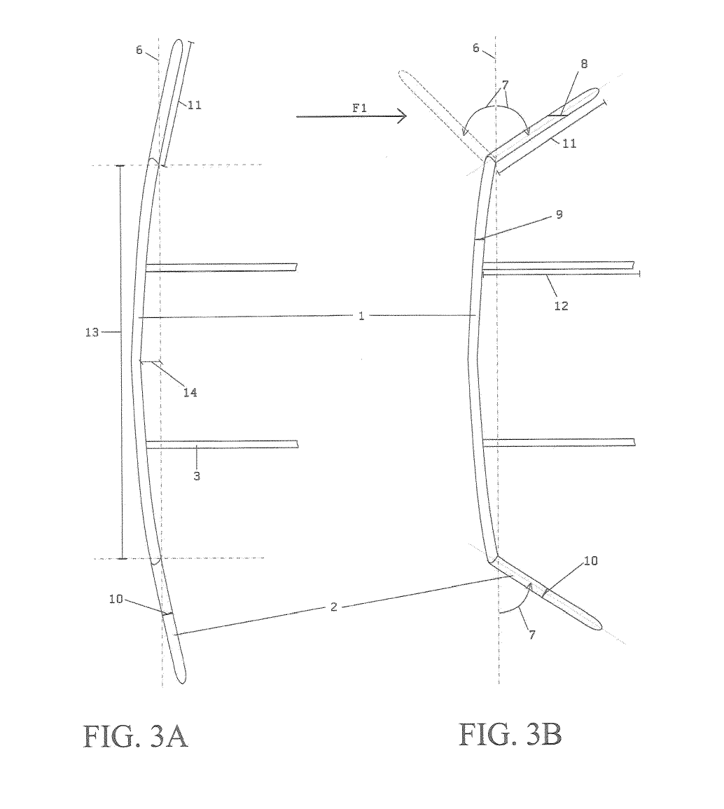

One of the most important evolutions in the disclosed subject matter relies in the vertical axis turbine blade's (1) ability to change its form or shape by adapting the turbine operation to installation location and to the fluid flow needs, by changing the blade end (2) position angle (FIGS. 3A-6C) thereby optimizing output energy production. By changing the blade's (1) form and/or orientation, the vertical axis turbine is able to use practically all the energy from the airflow or fluid when it reaches the rotor with any given angle from 0° to 360° in a vertical (4) or horizontal (5) plane as shown in FIG. 2.

The vertical axis turbines having these blades can be installed in a vertical or horizontal position (or range therebetween) with a lower concern about the orientation of the flow. The blades (1) can optimize their form in order to offer the turbine the ability to self-start and provide stability when it reaches high rotational speed. In one embodiment, the angle (7) of the blade ends (2) with respect of the main blade body (1), may vary between the inside and outside, respectively −90° to +90°, also between −45° to +45°, but even may extend beyond −90° to +90° because of optional blade inclinations.

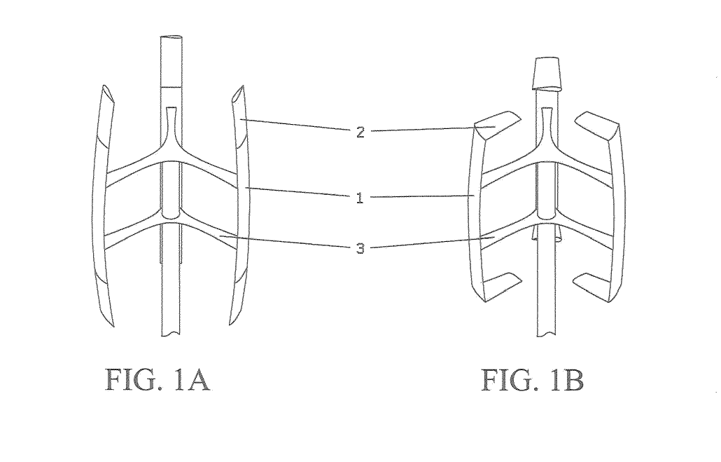

The turbines can have one or more of the blades as described here and as shown in FIG. 1. Each blade can include a main body (1) and two ends (2) and can be connected to a vertical rotational axis structure of the turbine by one or more arms (3).

The main body of the blade (1) can present any form and can include any symmetrical or asymmetrical airfoil. An elliptical form is presented in FIG. 3, where the ellipse small axis (14) has a transverse position in relation to the rotor. The form of the main body of the blade (1) and its length (13) can be designed in accordance with principles that would provide the most adequate structure with respect to a particular installation site.

The blade ends (2) can be positioned with any given angle (7) in relation to the blade axis (6) to the inside or outside of the rotor. The blade ends (2) can present any length (11) that it is determined to be more/most adequate with respect to the turbine installation site, but it is not advisable to be higher than 90% of the length (12) of the arm (3), in order to reduce the induction of undesirable flow turbulence that reduces the ability to self-start and which generates noise.

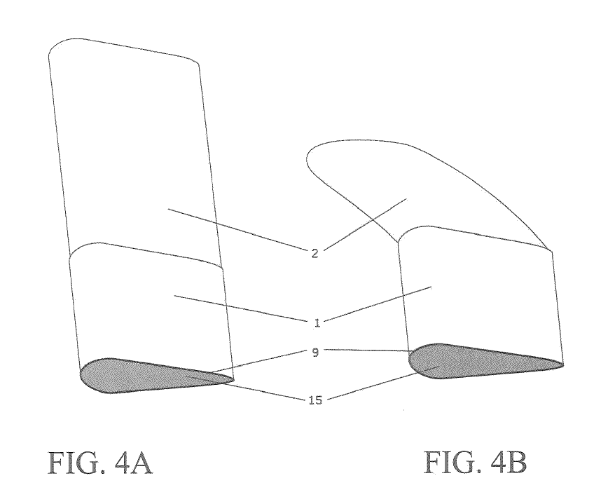

FIG. 4 illustrates additional features of the disclosed embodiment. The blade ends (2) can go from a position having a 0° angle (7) to any position angle (7) towards the inside or outside of the rotor automatically or manually during the turbine operation, installation or production, through a mechanical mechanism installed at the inside (15) of the blade (1).

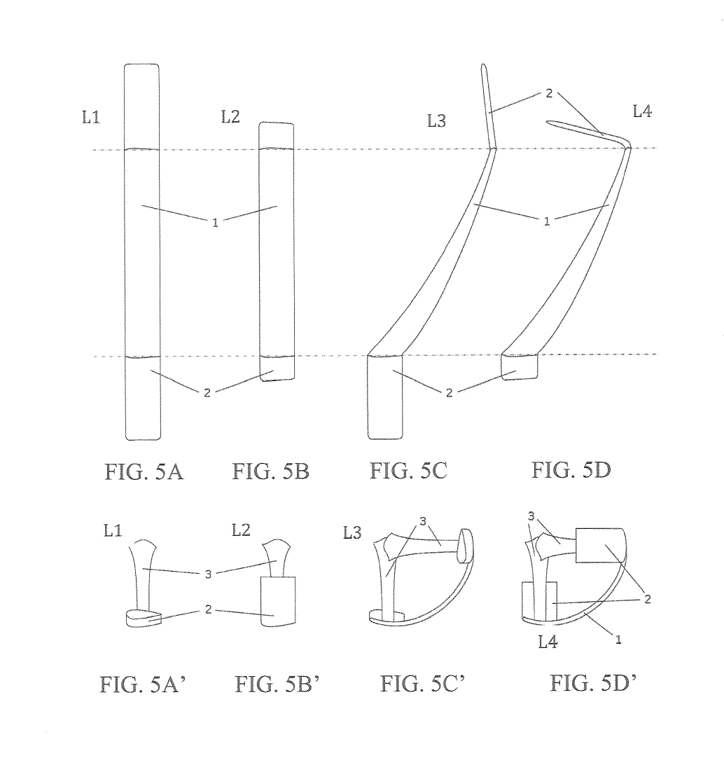

The blades may present any form that is found to be more adequate to the installation site characteristics. FIGS. 5A-D′ present two possible forms for the main body of the blade (1):
Vertical form (L1) (L2)—adapted for sites with high variations of flow velocity and at a lower cost of production. It presents a vertical form parallel to the rotor rotational axis structure and its ends are placed in the same position in relation to the rotor;
Helical form (L3) (L4)—adapted for sites with predominant low speed flows. The blades are warped around the rotational axis structure of the rotor, and its ends are placed in different radial positions in relation to the rotational axis structure of the rotor;

The main body of the blade (1) and its ends (2) can have different profiles (9, 10) with any symmetrical or asymmetrical form, which is found to be the more adequate with respect to the installation site in order to increase the self-start ability of the turbine and to optimize its behavior at high rotational speed.

When the blade ends change their position towards the inside or outside of the rotor, the flow angle when it reaches the blade ends (2) changes too, leading to an increase of the blade profile height (8) as it is found by the wind in comparison to the normal blade main body profile (9) and blade ends profile (10) when the flow reaches the turbine (F1) at any angle in a vertical (4) or horizontal (5) plane. This increase of the profile height leads to an increase of drag and changes the lift force action axis optimizing the turbine's self-start ability and stabilizes the blade movement when the turbine reaches high rotational speed.

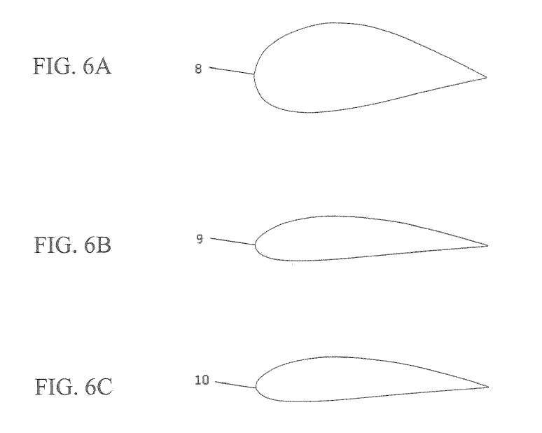

FIG. 3 shows the flow movement (F1) perpendicular to the turbine axis. When this flow reaches the turbine ends (2) when they are positioned towards the inside of the rotor (B) at a given angle (7), it finds a profile with an airfoil (8) shown in FIG. 6 that has a higher height than the profile (10) that it would have found if the blade ends (2) where in position (A). FIG. 6 shows the different airfoil heights that are represented in FIG. 3.

The blade arms (3) that connect the blade (1) to the rotor can present any aerodynamic profile suitable to reduce the drag.

The turbine blades can be installed in sets of more than one unit. In addition, the articulation between different portions of each of the blades can be accomplished by various means, such as mechanical linkages, gearing, hydraulic or pneumatic articulation joints, servo motors, separate articulated joints that are independently removed and replaced for differing operating conditions, combinations of the above, and other known articulating apparatus.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vertical axis turbine blade, comprising:
a main blade body configured to rotate about a rotational axis of a rotor;
at least one of a first end and a second end connected to the main blade body, wherein the at least one of the first end and second end is configured to articulate with respect to the main blade body at a variable position angle relative to the main blade body, the variable position angle being oriented one of, towards an inside of the rotor, towards an outside of the rotor, and parallel with the rotational axis of the rotor.

2. The blade according to the claim 1, wherein both the first end and second end are configured to articulate at a variable position angle being oriented towards the inside of the rotor.

3. The blade according to the claim 1, wherein said blade is elliptical in shape and a small axis of the elliptical shape has a transverse position in relation to the rotor.

4. The blade according to claim 1, further comprising one or more arms connected to the blade and extending towards and substantially perpendicular to the rotational axis of the rotor.

5. The blade according to claim 1, wherein the variable position angle of the first end and second end of the blade is fixed during fabrication.

6. The blade according to claim 1, wherein the variable position angle of the first end and second end of the blade is variable during operation.

7. The blade according to claim 1, further comprising a mechanism inside the blade, the mechanism arranged such that the first end and second end of the blade are capable of having a variable position angle, either towards the inside or the outside of the rotor.

8. The blade according to claim 1, wherein the first end and second end of the blade are located substantially at a same rotational degree location spaced about the rotational axis such that a longitudinal axis of the blade as viewed from a side view is substantially parallel with the rotational axis.

9. The blade according to claim 1, wherein the first end and second end of the blade are not located at a same rotational degree location spaced about the rotational axis such that the blade is helical with respect to the rotational axis.

10. The blade according to claim 1, wherein a blade end profile height, when a variable position angle is not null, from an airflow perspective, is substantially higher than a normal blade main body profile height and the blade ends profile when the variable position angle is null.

11. A vertical axis turbine including at least one blade according to claim 1, comprising:
a rotational axis structure;
at least one arm connecting the blade to the rotational axis structure.

12. The blade according to claim 1, wherein at least one of the first end and second end is oriented at an angle of 0 to 90 degrees with respect to the main blade body.

13. A vertical axis turbine, comprising:
a vertical rotational axis structure having a rotational axis;
at least one turbine blade located adjacent the vertical rotational axis structure and configured to rotate about the rotational axis of the vertical rotational axis structure;
at least one arm connecting the at least one turbine blade to the vertical rotational axis structure;
the at least one turbine blade having a main body and at least one of a first end and a second end, wherein the at least one of the first end and the second end is configured to be oriented at a variable angle relative to the main body.

14. The vertical axis turbine according to claim 13, wherein the variable angle ranges from 0 to 90 degrees relative to the main body.

15. The vertical axis turbine according to claim 13, wherein the first end and the second end are located at opposite ends of the main body of the turbine blade, and each of the first end and the second end includes structure configured to allow the respective one of the first end and second end to be variably angled with respect to the main body of the turbine blade.

16. The vertical axis turbine according to claim 13, wherein the first end and the second end are located at opposite ends of the main body of the turbine blade, and at least one of the first end and the second end includes structure configured to allow the one of the first end and second end to be variably angled with respect to the main body of the turbine blade.

17. The vertical axis turbine according to claim 13, wherein the main body of the turbine blade has a curved concave shape with the concave shape facing the vertical rotational axis structure.

18. The vertical axis turbine according to claim 13, wherein a longitudinal axis of the turbine blade is located substantially in a same plane as the rotational axis of the vertical rotational axis structure.

19. The vertical axis turbine according to claim 13, wherein a longitudinal axis of the turbine blade is configured such that the turbine blade extends about the rotational axis structure in a helical nature.

20. The vertical axis turbine according to claim 13, including a plurality of the at least one turbine blade and a plurality of the at least one arm, each of the plurality of arms connecting a respective one of the plurality of turbine blades to the vertical rotational axis structure, and each of the arms having a longitudinal axis substantially normal to the rotational axis of the vertical rotational axis structure.
